(19) United States
(12) Patent Application Publication
(10) Pub. No.: US 2021/0214285 A1
(43) Pub. Date: Jul. 15, 2021

(54) EMULSION FOR TREATING UREA-CONTAINING FERTILIZERS

(71) Applicant: EUROCHEM AGRO GMBH, Mannheim (DE)

(72) Inventors: Thomas MANNHEIM, Untermuenkheim (DE); Heiko HABERMUELLER, Weinheim (DE)

(21) Appl. No.: 17/058,984

(22) PCT Filed: Jun. 3, 2019
(86) PCT No.: PCT/EP2019/064251

§ 371 Date: Nov. 25, 2020

(30) Foreign Application Priority Data
Jun. 4, 2018 (DE) 10 2018 208 770.9

(51) Int. Cl. C05G 3/90; C05G 5/30; C05G 5/12; B01F 3/08

(52) U.S. Cl. CPC C05G 3/90; B01F 3/0811; C05G 5/12; C05G 5/30

(57) ABSTRACT

The invention relates to an emulsion for treating urea-containing fertilizers, containing an aqueous phase B and a non-aqueous phase A, which is emulsified with phase B, wherein phase A contains at least one (thio)phosphoric acid triamide of the general formula (I) and/or (thio)phosphoric acid diamide of the general formula (II), R¹R²N—P(X)(NH₂)₂, R¹O—P(X)(NH₂)₂ where X means oxygen or sulfur, R¹ and R² mean, independently of each other, hydrogen, respectively substituted or unsubstituted 2-nitrophenyl, C₁₋₁₀ alkyl, C₃₋₁₀ cycloalkyl, C₃₋₁₀ heterocycloalkyl, C₆₋₁₀ aryl, C₆₋₁₀ heteroaryl or diaminocarbonyl, wherein R¹ and R², together with the nitrogen atom connecting them, can also form a 5 or 6-membered saturated or unsaturated heterocyclic group, which can optionally also contain one or two additional heteroatoms, selected from the group consisting of nitrogen, oxygen and sulfur, as component A1, dissolved in an organic solvent, which is not miscible with water, as component A2, and wherein phase B 2-(N-3,4-dimethylpyrazole)succinic acid, which is present as dialkali salt, earth alkali salt, diammonium salt or a mixture thereof, as component B1, dissolved in water.

The invention relates to an emulsion for treatment of urea-containing fertilizers comprising at least one (thio)phosphoric acid triamide and 2-(N-3,4-dimethylpyrazole)succinic acid and to the use thereof, and to a process for producing treated urea-containing fertilizers and to the urea-containing fertilizers thus obtainable.

The predominant amount of the nitrogen used globally for fertilization is in the form of urea or urea-containing fertilizers, and is continuing to rise. However, urea itself is a form of nitrogen which is barely absorbed, if at all, since it is hydrolyzed relatively rapidly by the urease enzyme which is ubiquitous in the soil to give ammonia and carbon dioxide. Under some circumstances, gaseous ammonia is released to the atmosphere, which is then no longer available for the plants in the soil, which reduces the efficiency of the fertilization.

It is known that nitrogen exploitation in the use of urea-containing fertilizers can be improved by deploying urea-containing fertilizers together with substances that can reduce or inhibit enzymatic urea cleavage. The most potent urease inhibitors known include N-alkylthiophosphoric acid triamides and N-alkylphosphoric acid triamides, which are described, for example, in EP 0 119 487.

It is also possible to use mixtures of N-alkylthiophosphoric acid triamides such as N-(n-butyl)thiophosphoric acid triamide (NBPT) and N-(n-propyl)thiophosphoric acid triamide (NPPT), for example in a weight ratio of NBPT to NPPT of about 3:1.

These urease inhibitors are described, for example, in WO 2009/079994. For this compound class to be effective as urease inhibitor, there must first be conversion to the corresponding oxo form. Subsequently, this reacts with the urease and brings about the inhibition thereof.

It is advisable to apply the urease inhibitors to the soil together with the urea, since it is ensured in this way that the inhibitor comes into contact with the soil together with the fertilizer. The active ingredient may be incorporated here within the urea, for example in that it is dissolved in the melt before the urea granulation or the prilling. A further option is to apply the active ingredient to the urea granules or prills, for example in the form of a solution.

Corresponding methods of application and suitable solvents are described, for example, in EP-A-1 820 788. Solvents mentioned are water, alcohols, glycols or amines, and mixtures thereof. In addition, reference is made to WO 97/22568.

WO 97/22568 relates to improved formulations of N-alkylthiophosphoric acid triamides that are applied to fertilizers as urease inhibitors. They are dissolved here in a glycol or glycol derivative. More particularly, propylene glycol or dipropylene glycol is used, which are water-miscible glycols.

WO 2009/079994 relates to mixtures for treatment of urea-containing fertilizers likewise comprising (thio)phosphoric acid triamides. They additionally include at least one compound containing an amino group or a substituted amino group and having a boiling point of more than 100° C. Also described are solvents for the (thio)phosphoric acid triamides, including water, alcohol, glycols, N-methyl-2-pyrrolidone (NMP) or else dimethyl phthalate (DMP). Most of the solvents suggested, such as glycols and NMP, have good miscibility with water. Dimethyl phthalate, which is used according to the examples, has sparing solubility in water.

EP-A-3 109 223 relates to mixtures for treatment of urea-containing fertilizers. The synergistic mixture of urease inhibitor and nitrification inhibitor contains (thio)phosphoric acid triamides and 2-(N-3,4-dimethylpyrazole)succinic acid. The synergistic mixtures are applied to urea-containing fertilizers, and a mixture of the two components may also contain a solvent for the (thio)phosphoric acid triamides. The mixtures themselves are used as additive or coating composition for urea-containing nitrogen fertilizers. Solvents mentioned are water, alcohols, glycols, and also NMP or dimethyl phthalate. The manner and sequence of application to the urea-containing fertilizer is not specified in detail.

WO 2013/121384 relates to mixtures for reducing the emissions of ammonia or nitrogen oxides from soils. The mixtures comprise alkylthiophosphoric acid triamides and at least one strobilurin. They may additionally comprise nitrification inhibitors such as 2-(N-3,4-dimethylpyrazole)succinic acid or 3,4-dimethylpyrazole phosphate. Also mentioned is the additional use of solvents. The ingredients dissolved in an organic solvent may be emulsified in water.

DE 103 17 895 A1 relates to 1,3,4-oxa- and 1,3,4-thiadiazol-2-yl(thio)phosphoric acid triamides, to processes for preparation thereof and to the use thereof as regulators or inhibitors of enzymatic urea hydrolysis. The description states that the urease inhibitor is water-soluble. Problem-free combinability with nitrification inhibitors is suggested. It is also stated that the urease inhibitors can be used in liquid form, for example as a solution, emulsion or suspension, or in solid form.

WO 2015/104699 A2 relates to combinations of novel nitrification inhibitors with fungicides or with (thio)phosphoric acid triamides and fungicides. The nitrification inhibitors of the formula (I) have an alkyne group. Additional nitrification inhibitors used, as well as those of the formula (I), may also be DMPP or DMPSA. The two compounds are mentioned in a longer list. It is stated that NBPT or nitrification inhibitor may be present in the form of solutions, emulsions, suspensions, dusts, powders, pastes or granules.

Typically, (thio)phosphoric acid triamides, such as NBPT and NPPT, and nitrification inhibitors, such as 2-(N-3,4-dimethylpyrazole)succinic acid (DMPSA) or 3,4-dimethylpyrazole phosphate (DMPP), are applied separately to fertilizers. This means that the active substances are applied successively in their respective formulations to urea granules. There are various reasons for this course of action: formulations containing both active ingredients in a solution have distinct disadvantages:

Firstly, the two substances cannot be brought into solution together in the desired concentration in aqueous media. This is possible in some organic solvents and mixtures, but there is very rapid breakdown of both active ingredients in such solutions. Coating of urea-containing fertilizers with NBPT and DMPSA or DMPP was therefore possible to date only via the circuitous route of sequential application of individual formulations. The disadvantage of such a course of action lies in the great technical complexity, since two coating steps and additionally further process steps are needed. This leads to a distinctly extended process duration. Furthermore, storage capacities must be provided for the intermediate storage of the semifinished fertilizer. Moreover, it was found in storage stability experiments that the NBPT concentrations decrease unexpectedly rapidly in the finished fertilizer in the course of storage.

It is an object of the present invention to provide a mixture of urease inhibitors and nitrification inhibitors which is suitable for application to urea-containing fertilizers and which avoids the disadvantages detailed. In addition, an improved process for producing fertilizers treated with urease inhibitor and nitrification inhibitor is to be provided, which is of low technical complexity and leads to treated fertilizers having elevated storage stability.

It is a further object of the present invention to provide a mixture for the treatment of urea-containing fertilizers, especially for urease inhibition, which is storage-stable over a prolonged period after application to urea-containing fertilizers, better withstands passage through different distribution stages, and protects the active ingredient applied to urea from breakdown or loss. The mixture is not to adversely affect the activity of the active ingredient.

The object is achieved in accordance with the invention by an emulsion for treatment of urea-containing fertilizers comprising an aqueous phase B and a nonaqueous phase A emulsified with phase B,

where phase A comprises at least one (thio)phosphoric acid triamide of the general formula (I) and/or (thio)phosphoric acid diamide of the general formula (II)

R¹R²N—P(X)(NH₂)₂ (I)

R¹O—P(X)(NH₂)₂ (II)

with the following definitions:

X is oxygen or sulfur,

R¹ and R² are independently hydrogen, respectively substituted or unsubstituted 2-nitrophenyl, C₁₋₁₀-alkyl, C₃₋₁₀-cycloalkyl, C₃₋₁₀-heterocycloalkyl, C₆₋₁₀-aryl, C₆₋₁₀-heteroaryl or diaminocarbonyl, where R¹ and R² together with the nitrogen atom connecting them may also form a 5- or 6-membered saturated or unsaturated heterocyclic radical that may optionally also contain one or two further heteroatoms selected from the group consisting of nitrogen, oxygen and sulfur, as component A1, dissolved in a water-immiscible organic solvent as component A2, and

where phase B comprises 2-(N-3,4-dimethylpyrazole)succinic acid, preferably in the form of a dialkali metal salt, alkaline earth metal salt, diammonium salt or mixture thereof, as component B1, dissolved in water.

The object is additionally achieved by use of such an emulsion as additive or coating composition for urea-containing nitrogen fertilizers.

The object is additionally achieved by a process for producing treated urea-containing fertilizers, comprising the steps of

a) separately producing phases A and B as defined above,

b) mixing phases A and B from step a) for production of an emulsion of phases A and B,

c) applying the emulsion from step b) to a particulate urea-containing fertilizer or introducing the emulsion from step b) into a particulate urea-containing fertilizer.

In one embodiment of the invention, the emulsion and the treated urea-containing fertilizer do not contain any strobilurin or are free of strobilurin, as defined, for example, in WO 2013/121384.

The object is additionally achieved in accordance with the invention by a urea-containing fertilizer obtainable by the process described above.

It has been found in accordance with the invention that the coating of urea-containing fertilizers with specific urease inhibitors and DMPSA as nitrification inhibitor is possible in a simple manner when the two active ingredients are first dissolved separately in mutually immiscible solvents, then an emulsion is prepared from the two solutions, and the urea-containing fertilizer is treated with the emulsion thus obtained.

It has been found in accordance with the invention that the urea-containing fertilizers thus produced have significantly improved storage stability with regard to the volatility of the active ingredients.

The NBPT concentration in particular remains constant over a significantly longer storage period than is the case after sequential application of the active ingredients. This suggests that the active ingredients are adsorbed on the surface of the urea-containing fertilizer in a different form than by the known processes, so as to result in a differently treated urea-containing fertilizer as well.

The use of the emulsion of the invention for coating of the urea-containing fertilizer leads to altered physical properties of the fertilizer.

Thus, the emulsion of the invention permits not just simple and efficient simultaneous application of both active ingredients to urea-containing fertilizers, but results in a distinctly longer shelf life of the product compared to treated fertilizers produced by existing processes.

By contrast with DMPSA, especially the neutralized form or salt form, the use of DMPP in place of DMPSA in the emulsion of the invention and in the process of the invention does not lead to products having distinctly longer shelf life with regard to the urease inhibitor and nitrification inhibitor. Especially for the DMPP/NBPT combination, rapid degradation characteristics of both substances were observed when they were used in an emulsion corresponding to the emulsion of the invention.

The two active substances, (thio)phosphoric acid triamide and/or (thio)phosphoric acid diamide as urease inhibitor and DMPSA as nitrification inhibitor, are used in their respective individual formulations. DMPSA is used in an aqueous solution that preferably has a pH in the range from 6 to 9, more preferably from 7 to 8. Therefore, DMPSA is preferably used in neutralized form as a dialkali metal salt, alkaline earth metal salt, diammonium salt or mixture thereof. The urease inhibitor is dissolved in a water-immiscible organic solvent and preferably admixed with a compound containing an amino group or a substituted amino group, especially an amine, having a boiling point of more than 100° C. Amines here are preferably understood to exclude heterocycles, such as pyrazoles, or dicyandiamide (DCD).

The two formulations, which are mutually immiscible, are combined in a particular mixing ratio and homogenized by brief mixing to give an emulsion. This emulsion is typically not stable over time, but leads to phase separation again even after being left to stand for a few minutes, especially if no dispersing aid is used as well.

This emulsion mixture is applied as soon as possible after production uniformly to the urea-containing fertilizer, preferably in a mixture with agitation of the urea-containing fertilizer. The mixing operation is preferably continued for a few minutes after the application has ended. The finished treated urea-containing fertilizer can be dried by leaving it to stand in an open sack for several days, for example. If necessary, a separate drying step can be conducted.

DMPSA (especially in neutralized form) has good water solubility and does not break down in water. In the case of treatment of the solid particulate urea-containing fertilizer, the water is drawn rapidly into the fertilizer.

The emulsion for treatment of urea-containing fertilizers permits synergistic combination of urease inhibition and nitrification inhibition.

In this way, the additional emission of ammonia that typically occurs by virtue of the DMPSA nitrification inhibitor present can be suppressed.

By comparison with urease inhibitors and nitrification inhibitors used separately, it is possible to achieve a comparable effect with lower application rates.

Nitrogen losses from the urea-containing fertilizer on application are avoided by the mixture of the invention.

The urea-containing fertilizer contains the emulsion of the invention in such an amount that the total content of components A and B, based on the urea present, is preferably 0.001% to 0.5% by weight, preferably 0.02% to 0.4% by weight, especially 0.08% to 0.25% by weight.

It has been found in accordance with the invention that, in particular, 2-(N-3,4-dimethylpyrazole)succinic acid (also referred to as DMPSA or DMPBS) in a mixture with (thio)phosphoric acid triamides of the general formula (I) and/or (thio)phosphoric acid diamides of the general formula (II) results in synergistically active mixtures for treatment of urea-containing fertilizers.

The respective customary use amounts of urease inhibitor (component A) and nitrification inhibitor (component B) have been distinctly lowered in accordance with the invention without significant loss of activity, such that the total amount of active ingredient in the mixture is only about half of that in the case of application of the individual substances.

As stated above, the urease enzyme hydrolyzes urea relatively rapidly to ammonia and carbon dioxide. Use of urease inhibitors can delay or slow this process.

Nitrification inhibitors prevent the premature conversion of nitrogen in fertilizers to nitrate, which can simply be washed out by rainwater, for example, and hence is lost to the plants.

Typical nitrification inhibitors such as 3,4-dimethylpyrazole typically increase ammonia emissions from urea-containing fertilizers significantly, partly because the pH after hydrolysis remains in the basic range for longer. There is distinctly higher ammonia emission potential at the elevated pH values than at lower pH values. The formation of N₂O and the washout of nitrate are lowered by use of a nitrification inhibitor, but this desired effect is at the cost of elevated ammonia emissions and hence loss of nitrogen via ammonia.

Therefore, it is common to use a urease inhibitor on urea-containing fertilizers, but not a nitrification inhibitor.

The (thio)phosphoric acid triamides of the general formula (I) or (thio)phosphoric acid diamides of the general formula (II), especially N-(n-butyl)thiophosphoric acid triamide (NBPT) or N-(n-propyl)thiophosphoric acid triamide (NPPT), prevent or limit the emission of ammonia from urea and the additional ammonia emissions in the case of additional use of 2-(N-3,4-dimethylpyrazole)succinic acid as nitrification inhibitor. This means that not only is the nitrification sufficiently inhibited by the nitrification inhibitor used and losses of dinitrogen monoxide are greatly reduced, but ammonia losses are also reduced to such an extent that the urea is stabilized for longer.

This effect occurs specifically in the case of use of the DMPSA nitrification inhibitor of the invention in combination with the urease inhibitors of the invention. The nitrification inhibition and urease inhibition are maintained alongside one another with a reduced use amount of both active ingredients; see the results described in EP-A-3 109 223.

As a result, in the case of joint application of the nitrification inhibitor DMPSA and the urease inhibitor NBPT, the effects of the two inhibitors are maintained and mutually enhance one another in such a way that the total use amount of the two active ingredients can be reduced by more than half.

Compared to the typical use amount of the individual substances in the case of sole use, it is possible to reduce the amount by up to ⅔ for DMPSA (for example from 0.36% by weight to 0.12% by weight), by up to ⅓ in the case of NBPT (for example from 0.06% by weight to 0.04% by weight), based in each case on urea. Since DMPSA is typically used in a significantly greater amount than NBPT, the significant reduction in the amount thereof is all the more important.

Component A1 used is at least one (thio)phosphoric acid triamide of the general formula (I) and/or one (thio)phosphoric acid diamide of the general formula (II). These may be individual compounds or else mixtures of two or more such compounds. For example, they may be mixtures as described in EP-A-1 820 788.

The R¹ and R² radicals may each be unsubstituted or substituted, for example by halogen and/or nitro.

Examples of alkyl groups are methyl, ethyl, propyl, isopropyl, n-butyl, isobutyl, sec-butyl, tert-butyl, pentyl, isopentyl, neopentyl, tert-pentyl, hexyl, 2-methylpentyl, heptyl, octyl, 2-ethylhexyl, isooctyl, nonyl, isononyl, decyl and isodecyl. Cycloalkyl groups are, for example, cyclopropyl, cyclobutyl, cyclopentyl, cyclohexyl and cyclooctyl; aryl groups are, for example, phenyl or naphthyl or substituted 2-nitrophenyl. Examples of heterocyclic radicals R₁R₂N— are piperazinyl, morpholinyl, pyrrolyl, pyrazolyl, triazolyl, oxazolyl, thiazolyl or imidazolyl groups.

Such compounds are known as urease inhibitors, for example, from EP 0 119 487, WO 00/58317 and EP 1 183 220.

One example of compounds of the formula (II) is phenyl phosphorodiamidate.

Preference is given to formulations comprising N-(n-butyl)thiophosphoric acid triamide (NBPT) as one or the only active ingredient (component A1). If a further active ingredient is used as well, this is preferably a derivative selected from the group consisting of N-cyclohexyl-, N-pentyl-, N-isobutyl- and N-propylphosphoric acid triamide and corresponding thiophosphoric acid triamides. Preference is given to additional use of NPPT. Particular preference is given to those formulations containing NBPT or a mixture of NBPT and NPPT in amounts of 40% to 100% by weight, most preferably of 60% to 100% by weight, based in each case on the total amount of active ingredient of component A1. In a mixture of NBPT and NPPT, the compounds are preferably present in a weight ratio of 19:1 to 1:19, preferably of 9:1 to 1:9, more preferably of 8:2 to 2:8, especially preferably of 1:1 to 5:1, in particular of 2:1 to 4:1, for example of about 3:1 (75%:25%).

More preferably, solely NBPT or a mixture of NBPT and NPPT, preferably in a weight ratio of 2:1 to 4:1, is used as component A1.

Thiophosphoric acid triamides are known to be converted relatively readily to the corresponding phosphoric acid triamides. Since moisture generally cannot be entirely ruled out, thiophosphoric acid triamide and the corresponding phosphoric acid triamide are frequently present in a mixture with one another. The expression “(thio)phosphoric acid triamide” in this document therefore refers both to the pure thiophosphoric acid triamides or phosphoric acid triamides and to mixtures thereof.

Particular preference is given to N-alkylthiophosphoric acid triamides (with X═S and R²═H) and N-alkylphosphoric acid triamides (with X═O and R²═H).

Such urease inhibitors can be prepared, for example, by known methods from thiophosphoryl chloride, primary or secondary amines and ammonia, as described, for example, in U.S. Pat. No. 5,770,771. In this case, in a first step, thiophosphoryl chloride is reacted with one equivalent of a primary or secondary amine in the presence of a base, and the product is then converted to the end product with an excess of ammonia.

Further suitable urease inhibitors that may optionally be used in addition are described, for example, in WO 00/61522, WO 00/58317, WO 02/083697, WO 01/87898, WO 2006/010389. The compounds described therein are, for example, thiophosphoric acid triamides, heterocyclically substituted (thio)phosphoric acid triamides, N-(2-pyrimidinyl)(thio)phosphoric acid triamides and N-phenylphosphoric acid triamides.

EP-A-1 820 788 especially describes mixtures of N-(n-butyl)thiophosphoric acid triamide and N-(n-propyl)thiophosphoric acid triamide.

These mixtures may be used with particular preference in accordance with the invention as well as the individual substances.

The (thio)phosphoric acid triamides of the general formula (I) or (thio)phosphoric acid diamides of the general formula (II) that are used as component A1 may be pure substances or mixtures of two or more pure substances. As a result of the synthesis, they may also contain by-products from the active ingredient synthesis. In general, component A1 is present in a purity of at least 70%.

Component A1 is dissolved in a water-immiscible organic solvent (component A2). The expression “water-immiscible” describes organic solvents having a solubility in water of not more than 1 g/l at 20° C. The solubility in water is preferably not more than 100 mg/l at 20° C.

Suitable solvents are selected from water-immiscible alcohols, ethers, esters, hydrocarbons, polyalkylene polyols, such as water-immiscible polyalkylene glycols or glycol derivatives, and ethers thereof, liquid amides or mixtures thereof, preferably from water-immiscible alcohols, ethers, esters or mixtures thereof.

Component A2 is preferably selected from 2-propyl-1-heptanol, benzyl alcohol, dimethyl phthalate or mixtures thereof. 2-Propylheptan-1-ol, for example, has a water solubility of only 58 mg/l at 20° C. and is thus considered to be water-insoluble.

Phase A contains preferably 15% to 35% by weight, more preferably 20% to 30% by weight, especially 22% to 26.5% by weight of component A1, based on the total weight of phase A.

In addition, phase A may also include at least one compound containing an amino group or a substituted amino group or an amine having a boiling point of more than 100° C. as component A3.

Preferably, component A3 is water-immiscible; see the definition above.

This compound is preferably selected from methyldiethanolamine, tetrahydroxypropylethylenediamine, trimethylaminoethylethanolamine, N,N,N′,N′-tetramethylhexane-1,6-diamine, N,N′,N″-tris(dimethylaminopropyl)hexahydrotriazine, 2,2′-dimorpholinyldiethyl ether, N,N,N′,N′,N″,N″-hexamethyl-1,3,5-triazine-1,3,5(2H,4H,6H)-tripropanamine, N,N,N′,N′-tetrakis(2-hydroxypropyl)ethylenediamine or mixtures thereof, where component A3 is preferably used in at least 0.2 times the molar amount of component A1. One function of the amine is to stabilize the urease inhibitor in the organic solution.

The active ingredient of component A1 applied to urea often has distinctly higher storage stability (at least 2 to 3 months) when it is used in combination with at least one amine having a boiling point of more than 100° C. as component A3. Component A3 contains at least one amino group, for example primary, secondary or tertiary amino group, where any further functional groups and radicals, for example hydroxy, halogen, carboxy, carbamoyl, carbonyl, oxyalkyl, mercapto, n-sulfido, sulfoxy, sulfo, phospho, siloxy, amino, amido, imino, imido, oxyamido groups etc. may be present in the compound. Component A3 is elucidated in detail hereinafter by way of example as amine.

The amine of component A3 preferably has a boiling point of more than 150° C., more preferably of more than 200° C., at ambient pressure (1 bar). The amines may be primary, secondary or tertiary amines or polyamines bearing two or more of these amino groups. Amines used are preferably secondary and/or tertiary amines. Particular preference is given to using tertiary amines that may also be in polymeric form. Preference is given to using those amines that do not enter into any chemical reaction with the active ingredient of component A1 or the solvent additionally used in component A2. For example, the amines of component A3 are selected from methyldiethanolamine, tetrahydroxypropylethylenediamine, trimethylaminoethylethanolamine, N,N,N′,N′-tetramethylhexane-1,6-diamine, N,N′,N″-tris(dimethylaminopropyl)hexahydrotriazine, 2,2′-dimorpholinyldiethyl ether or mixtures thereof.

For further suitable amines, reference may be made to WO 2016/103168, especially the amines of groups L10 to L24 and L29 that are disclosed therein. Further suitable amines are described in WO 2015/001457; see especially component (C) therein and specifically the amines described as components (C1) to (C5). Further suitable amines are described in WO 2018/007426, especially as component B therein, selected from B1 to B4 among the general formulae (III) to (X). Reference may also be made to amino alcohols as described, for example, in WO 2013/090324.

Amines are understood to mean ammonia derivatives in which the hydrogen atoms have been exchanged for organic molecular radicals. Molecules in which all three hydrogen atoms have been exchanged are referred to as tertiary amines, those in which two hydrogen atoms have been exchanged as secondary amines, and those in which one hydrogen atom has been exchanged as primary amines.

Compounds having a C═N bond as in the case of pyridine are not part of the amine classification of the invention.

The saturated cyclic amines such as piperidine, pyrrolidine, just like their (unsaturated) aromatic representatives pyridine and pyrrole, are regarded as heterocyclic compounds and hence not as amines.

The cyano group —CN is likewise not a tertiary amino group, and hydrogen cyanide (H—CN) is not a tertiary amine.

The generic expression “amines” is thus used for compounds NH₂R, NHR¹R² and NHR¹R²R³ that are called primary, secondary and tertiary amines respectively. In a further sense, compounds that contain nitrogen as part of a ring and the basicity of which can be attributed to this atom can also be referred to as “amines”. For example, piperidine, according to its chemical structure, is a cyclic secondary amine.

Amines such as N-methylpyrrolidone (NMP), for example, have no stabilizing effect and hence are also not considered as amines usable in accordance with the invention.

Dicyandiamide (DCD) is likewise not an amine, but an amide going by the chemical name alone. This is a cyanamide and guanidine derivative having no significant basicity.

According to the invention, the term “amines” thus includes neither pyridines nor guanidines, urea, thiourea or dicyandiamide. (Thio)phosphoric acid triamides, being amides, are also not included among the amines in accordance with the invention.

Component A3 is used in an amount sufficient to increase the storage stability of the active ingredient of component A1 on urea-containing fertilizers. Component A3 should preferably be used in at least 0.2 times the molar amount of component A1, more preferably in 0.5 to 3 times the molar amount, especially in 1 to 2 times the molar amount.

Addition of polymeric auxiliaries can additionally further enhance the stabilizing action.

According to the invention, as a further component C, polymers may be present in dissolved or dispersed form in phase A. Preference is given here to those polymers that do not enter into any chemical reactions with components A1 and B1. The polymers may be used in solution or emulsion or in dispersed form. Preference is given to using soluble polymers that preferably have a number-average molecular weight of at least 5000. Suitable polymers may derive from vinylic monomers, for example from styrenes or (meth)acrylates or acrylonitrile. For example, it is possible to use soluble polystyrenes, soluble polystyrene-acrylonitrile polymers or else those polymers containing graft rubbers. In addition, for example, it is possible to use polyesters or polyalkylene glycols. The stabilization of the urease inhibitors of component A1 is improved again by the addition of the polymers. They can also be used for delayed release of the mixture in the manner of a controlled release. The constituents are preferably present in the mixture in the amounts that follow.

The proportion of the amine of component A3 in phase A of the invention, if present, is preferably 1% to 50% by weight, more preferably 2% to 40% by weight, especially 3% to 35% by weight. The amount of the optional polymer component C is preferably 0% to 50% by weight, especially 0% to 25% by weight. In the presence of component C, the amount is preferably 1% to 50% by weight, especially 2% to 25% by weight. The total amount of the components of phase A is 100% by weight.

As component B1, the emulsion of the invention contains 2-(N-3,4-dimethylpyrazole)succinic acid (DMPBS or DMPSA) as a pyrazole compound having nitrification-inhibiting action. This compound is known from the prior art and described, for example, in WO 96/24566, WO 2011/032904 and WO 2013/121384.

2-(N-3,4-Dimethylpyrazole)succinic acid is frequently an isomer mixture of 2-(3,4-dimethyl-1H-pyrazol-1-yl)succinic acid and 2-(2,3-dimethyl-1H-pyrazol-1-yl)succinic acid, in a ratio of preferably about 80:20. It is also possible to use one of the individual compounds. According to the invention, preference is given to using salts of this/these compound(s), for example (di)alkali metal salts, alkaline earth metal salts or (di)ammonium salts, preferably alkali metal salts, specifically potassium salts.

According to the invention, the name “DMPSA” or “DMPBS” is also understood to mean the aforementioned salts. Phase B preferably has a pH in the range from 6 to 9, more preferably from 7 to 8. The setting of this pH can be achieved via the use amount of alkali metal hydroxide, alkaline earth metal hydroxide or ammonia for neutralization of DMPSA.

Phase B should preferably have a pH very close to neutral, in order to avoid rapid hydrolysis of component A1 on contact between the two solutions. It is known that NBPT in particular breaks down rapidly in aqueous solutions and emulsions at lower pH values and is also unstable at higher pH values.

Component B1 is dissolved in water. The water here may additionally contain small amounts of water-soluble additional solvents, for example lower alkanols, N-methylpyrrolidone (NMP) or else optionally dimethyl sulfoxide (DMSO). The amount thereof may, for example, be up to 10% by weight, preferably up to 5% by weight, based on water and additional solvent. Preference is given to using water as the sole solvent for phase B. The expression “aqueous phase” describes a phase having a predominant content of water as solvent. It contains component B1 dissolved in water.

Preferably, phase B contains 20% to 60% by weight, more preferably 25% to 50% by weight, especially 30% to 40% by weight, of component B1, based on the total weight of phase B. The values relate to the free acid (DMPSA) or to the salt form thereof, preferably to the salt form. In the case of use of the free acid (DMPSA), the upper limit can be reduced to 45% by weight, preferably 40% by weight, especially 35% by weight.

More preferably, phase B contains solely DMPSA and KOH in a molar ratio of 2:1, dissolved in water.

2-(N-3,4-Dimethylpyrazole)succinic acid can be prepared by any suitable processes that are described in general form, for example, in WO 96/24566. The preparation is preferably effected by reacting 3,4-dimethylpyrazole with maleic acid or maleic anhydride. This reaction is typically performed in an acidic environment. For preparation of 3,4-dimethylpyrazole, reference may be made to Noyce et al., Jour. of Org. Chem. 20, 1955, pages 1681 to 1682. In addition, reference may be made to EP-A-0 474 037, DE-A-3 840 342 and EP-A-0 467 707, and also to EP-B-1 120 388 and EP-A-3 109 223.

In respect of the purification of 3,4-dimethylpyrazole, reference may be made to DE-A-102009 060 150.

A preferred preparation is given in EP-A-3 109 223.

Use of the reaction product of 3,4-dimethylpyrazole with maleic acid allows the volatility of the 3,4-dimethylpyrazole to be lowered significantly.

Preferably, the emulsion and hence both phase A and phase B are free of fungicides, as described, for example, in WO 2015/104699A2. Preferably, component A1 is not a 1,3,4-oxa- and 1,3,4-thiadiazol-2-yl(thio)phosphoric acid triamide of the general formula (I)

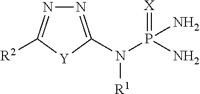

where the definitions in formula (I) are as follows:

X, Y=independently oxygen or sulfur;

R¹, R²=independently hydrogen, C₁-C₈-alkyl/heteroalkyl, C₂-C₈-alkenyl/heteroalkenyl, C₂-C₆-alkinylheteroalkynyl, C₃-C₈-cycloalkyl/heterocycloalkyl, C₃-C₈-cycloalkenyl/heterocycloalkenyl, C₆-C₁₀-aryl/heteroaryl, aralkyl, heteroarylalkyl, alkaryl, alkheteroaryl, alkoxy, aryloxy, hetaryloxy, alkylthio, arylthio, hetarylthio, acyl, aroyl, hetaroyl, acyloxy, aroyloxy, hetaroyloxy, alkoxycarbonyl, aryloxycarbonyl, hetaryloxycarbonyl, amino, alkylamino, dialkylamino, alkylsulfonyl, arylsulfonyl, fluorine, chlorine, bromine, iodine, hydroxy, cyano, nitro, sulfo, carbonyl, carboxy, carbamoyl, sulfamoyl, where the R¹ and/or R² radicals may optionally themselves and independently be substituted by one or more of the abovementioned groups.

Phases A and B are mixed with one another in such respective amounts to give an emulsion that components A1 and B1 are present in a weight ratio of 1:1 to 1:6, preferably 1:1.5 to 1:5, in particular 1:2 to 1:4.5, especially 1:2.5 to 1:4.

The emulsions of the invention may, in one embodiment of the invention, be free of emulsifiers or dispersants, such as surfactants, which are typically used for stabilization of oil/water emulsions. If, as is preferred, the emulsion is produced by mixing phases A and B immediately prior to the coating of the solid particulate urea-containing fertilizer, and the application to the fertilizer takes place immediately thereafter, the emulsions are sufficiently stable for this short requisite period of time, such that it is possible to dispense with the additional use of an emulsifying or dispersing aid. In that case, the emulsions are free of emulsifying or dispersing aids.

In an alternative embodiment of the invention, the emulsions contain emulsifiers/emulsifying aids or dispersants/dispersing aids. The amount thereof, when they are additionally used, is typically 0.01% to 5% by weight, preferably 0.02% to 2% by weight, especially 0.1% to 1% by weight, based on the sum total of phases A and B that adds up to 100% by weight. Suitable emulsifiers and dispersants/emulsifying and dispersing aids are known to the person skilled in the art. These may especially be anionic, cationic, nonionic or amphoteric surfactants. For example, it is possible to use nonionic surfactants such as alkylaryl polyether alcohols, as described, for example, in WO 97/22568. Particular preference is given in accordance with the invention to working without emulsifiers and dispersants/emulsifying and dispersing aids.

Preference is given to using solutions of maximum concentration in phase A and phase B, such that the proportion of solvents can be reduced. However, the total amount of the emulsion should be such that maximum homogeneity of coating of urea-containing fertilizers is possible, where the preferred contents of components A1 and B1 specified are applied to the fertilizer.

In the case of a standard concentration of 35% by weight of component B1 in phase B and 23% by weight of component A1 in phase A, phases A and B are preferably used in a weight ratio of 1:2 to 1:2.5, specifically about 1:2.3. In the case of different substance contents of phases A and B, the ratio has to be adjusted appropriately.

The typical amount of the emulsion applied to a urea-containing fertilizer is guided by the amide nitrogen content of the fertilizer and the amounts or concentrations of the active ingredients.

Fertilizer mixtures preferably contain 100 to 3000 ppm by weight, based on the urea in the fertilizer, of nitrification inhibitor (0.01% to 0.3% by weight), more preferably 0.03% to 0.2% by weight of DMPSA, especially 0.04% to 0.18% by weight of DMPSA. Preferably, the amounts are based on the free acid (DMPSA) and should be increased correspondingly when their salts are used, for example by a factor of 1.4.

The urea-containing fertilizer mixtures contain preferably 100 to 800% ppm by weight, based on the fertilizer, of component A1 (0.01% to 0.08% by weight), more preferably 0.01% to 0.07% by weight, especially 0.018% to 0.06% by weight, of component A1, especially NBPT.

Components A1 and B1 are present in the fertilizer preferably in a weight ratio in the range from 1:1 to 1:6, more preferably 1:1.5 to 1:5, in particular 1:2 to 1:4.5, especially 1:2.5 to 1:4.

The invention also relates to a urea-containing fertilizer containing an emulsion as described above in such an amount that the total content of components A1 and B1, based on the urea present, is 0.02% to 0.38% by weight. The content of components A1 and B1, based on the urea present, is more preferably 0.04% to 0.27% by weight, especially 0.058% to 0.24% by weight. In the urea-containing fertilizer, the emulsion has preferably been applied here to the surface of the urea-containing fertilizer.

The urea-containing fertilizers of the invention are produced by a process comprising the following steps:

a) separately producing phases A and B as defined above,

b) mixing phases A and B from step a) for production of an emulsion of phases A and B,

c) applying the emulsion from step b) to a particulate urea-containing fertilizer or introducing the emulsion from step b) into a particulate urea-containing fertilizer.

The mixing of phases A and B in step b) can be effected at room temperature or else at elevated temperature of, for example, 30 to 60° C. Particular preference is given to performing the mixing at a temperature in the range from 20 to 40° C.

Phases A and B can be mixed by a static or moving mixer, for example a stirrer system. Phases A and B are preferably mixed to produce an emulsion immediately prior to the application of the emulsion to the particulate urea-containing fertilizer, such that breakdown of the ingredients can be effectively prevented. There is preferably a period of not more than 60 and more preferably not more than 30 seconds between steps c) and b); in particular, the period should be kept as short as possible (less than 15 seconds).

Step c) is preferably a spray application and/or drum application of the emulsion to the urea-containing fertilizer. This preferably involves movement of the urea-containing fertilizer.

This can also be effected using further aids, such as adhesion promoters or coating materials. Suitable apparatuses for performance of this application are, for example, pans, drums, mixers or fluidized bed apparatuses, but the application can also be effected on conveyor belts or at discharge points therefrom or by means of pneumatic solids conveyors. Final treatment with anticaking agents and/or antidusting agents is likewise possible. The fertilizers or emulsions of the invention are used in fertilization with urea-containing fertilizers. Application is preferably effected in a soil area used for agriculture or horticulture, such as farmland.

The urea-containing fertilizer is in particulate form. It may be in the form of powder, prills, compactates or of other particles of regular or irregular shape.

In urea-containing fertilizers, the urea content is preferably 20% to 100% by weight, more preferably 50% to 100% by weight or 100% by weight. Further possible ingredients are the customary ingredients of NPK fertilizers.

A urea-containing fertilizer is understood to mean, first of all, urea itself. In typical market fertilizer quality, it has a purity of at least 90% and may, for example, be in crystalline, granulated, pelletized, prilled or ground form. Also included in addition shall be mixtures of urea with one or more further nitrogen fertilizers, such as ammonium sulfate, ammonium nitrate, ammonium chloride, cyanamide, dicyandiamide (DCD) or calcium nitrate, and slow-release fertilizers, for example urea-formaldehyde, urea-acetaldehyde or urea-glyoxal condensates. Also included in addition shall be urea-containing multinutrient fertilizers which, as well as nitrogen, also contain at least one further nutrient, such as phosphorus, potassium, magnesium, calcium or sulfur. In addition, the trace elements boron, iron, copper, zinc, manganese or molybdenum may also be present. Such urea-containing multinutrient fertilizers may likewise be granulated, compacted, prilled or ground, or may be in the form of a crystal mixture. The urea-containing fertilizers may also contain one or more further active ingredients, for example nitrification inhibitors, herbicides, fungicides, insecticides, growth regulators, hormones, pheromones or other crop protection agents or soil auxiliaries, in amounts of 0.01% to 20% by weight.

The invention also relates to a urea-containing fertilizer obtainable by the above process.

The emulsions of the invention may be used as additive or coating composition for urea-containing nitrogen fertilizers.

They may be deployed as additive on soil or plant substrate before, after or together with a urea-containing nitrogen fertilizer. The emulsion of the invention may be dosed separately from the urea-containing nitrogen fertilizer. More commonly, the emulsion of the invention will be applied as coating composition to the urea-containing nitrogen fertilizer. In the case of additional use as additive for urea-containing nitrogen fertilizers, the emulsions of the invention will preferably be used in the emulsions in an amount of 0.001% to 0.5% by weight, based on the weight of the urea in the nitrogen fertilizer and on components A1 and B1.

The invention is elucidated in detail by the examples which follow.

### EXAMPLES

In the examples which follow,

NBPT: N-(n-butyl)-thiophosphoric acid triamide=urease inhibitor UI

DMPSA or DMPBS: 2-(N-3,4-dimethylpyrazole)succinic acid=nitrification inhibitor NI

### A. Preparation Examples for 2-(N-3,4-dimethylpyrazole)succinic Acid (DMPSA)

Preparation is effected as described in EP-A-3 109 223 in example 1 or 2.

### B. Production of Phases A and B

79 g of a DMPSA formulation was prepared as a 35% by weight aqueous, pH-neutral formulation of DMPSA as the dipotassium salt.

35 g of an NBPT formulation was prepared as a 23% by weight anhydrous solution of NBPT in 2-propyl-1-heptanol with addition of 46% by weight of a mixture of N,N,N′,N′,N″,N″-hexamethyl-1,3,5-triazine-1,3,5(2H,4H,6H)-tripropanamine and N,N,N′,N′-tetrakis(2-hydroxypropyl)-ethylenediamine.

### C. Application of Phases A and B to the Fertilizer

20 kg of granulated urea was initially charged in a mixer. 35 g of the NBPT formulation and 79 g of DMPSA formulation were introduced into a spray bottle and shaken until a homogeneous emulsion had formed. The formulation emulsion was immediately sprayed onto the urea, with intermittent shaking of the spray bottle in order to prevent settling of the emulsion. The mixer was operated for a further 10 minutes until a homogeneous product was obtained.

In a comparative experiment, identical amounts of DMPSA and NBPT were applied to urea. DMPSA formulation was applied first to the urea by the method described above, and the NBPT formulation was applied after drying.

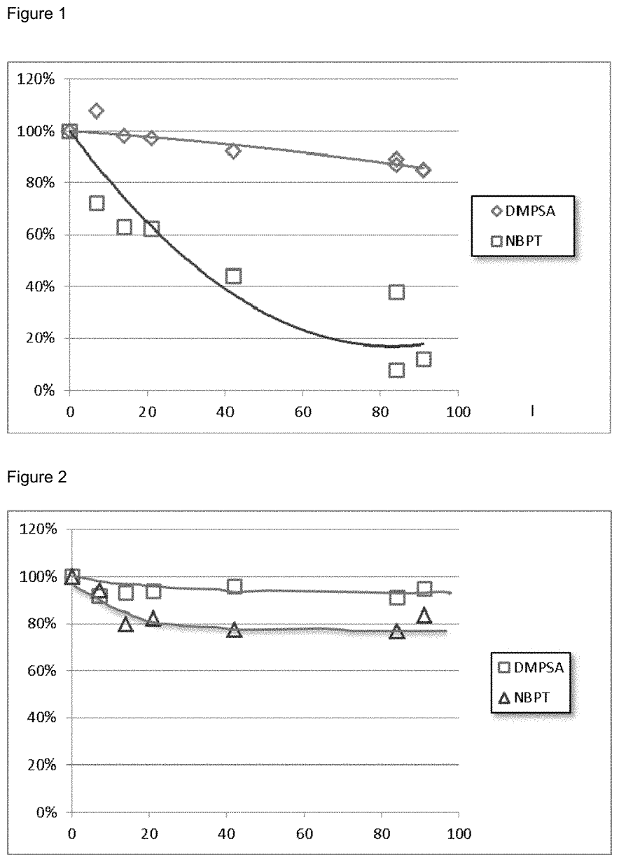

Storage stability tests were conducted for both the urea fertilizers treated. They were stored for a period of 90 days under standard conditions in a climate-controlled cabinet. The NBPT and DMPSA content was determined at time intervals. FIG. 1 shows the decrease in the NBPT and DMPSA content over time after the number of days specified for the comparative formulation.

FIG. 2 shows the results of the stability test for the urea-containing fertilizers of the invention in which DMPSA and NBPT were applied as an emulsion mixture.

It is clearly apparent from the figures that the decrease both in DMPSA and in NBPT was significantly smaller for the urea-containing fertilizers produced in accordance with the invention than in the comparative experiment.

### D. Dissolution Experiments

In addition, dissolution experiments were conducted for DMPSA and NBPT:

In aqueous media, the solubility of NBPT was much too small to obtain a sufficiently high concentration. The application rate of the solution would be too high for application to fertilizers.

Although both active substances were soluble in a sufficient amount in standard organic solvents, there were chemical reactions after a short time between NBPT and solvent constituents or between the two active substances, resulting in breakdown.

It can be inferred from this that there is no way of keeping the two active substances stable together in the same solvent system in suitable concentrations.

### E. Comparative Experiments

In the comparative experiment, rather than a DMPBS formulation, 79 g of a DMPP formulation in the form of a 35% by weight aqueous, pH-neutral formulation was used in phase B. Otherwise, the procedure was as described in examples B. and C.

For both treated urea fertilizers, rapid degradation characteristics were observed both for NBPT and for DMPP. After a period of 7 days, about 50% of the DMPP and 100% of the NBPT had been broken down. It can be concluded from HPLC chromatograms for the two urea fertilizers treated that there were chemical reactions between the two substances that lead to degradation of DMPP and NBPT.

1-18. (canceled)

19. An emulsion for treatment of urea-containing fertilizers, comprising an aqueous phase B and a nonaqueous phase A emulsified with phase B,
where phase A comprises at least one (thio)phosphoric acid triamide of the general formula (I)
and/or (thio)phosphoric acid diamide of the general formula (II)
R¹R²N—P(X)(NH₂)₂ (I)
R¹O—P(X)(NH₂)₂ (II)
with the following definitions:
X is oxygen or sulfur,
R¹ and R² are independently hydrogen, respectively substituted or unsubstituted 2-nitrophenyl, C₁₋₁₀-alkyl, C₃₋₁₀-cycloalkyl, C₃₋₁₀-heterocycloalkyl, C₆₋₁₀-aryl, C₆₋₁₀-heteroaryl, or diaminocarbonyl, where R¹ and R² together with the nitrogen atom connecting them may also form a 5- or 6-membered saturated or unsaturated heterocyclic radical that may optionally also contain one or two further heteroatoms selected from the group consisting of nitrogen, oxygen, and sulfur,
as component A1, dissolved in a water-immiscible organic solvent as component A2,
and
where phase B comprises 2-(N-3,4-dimethylpyrazole)succinic acid, as component B1, dissolved in water.

20. The emulsion of claim 19, wherein the (thio)phosphoric acid triamides of the general formula (I) used are N-alkylthiophosphoric acid triamides with the definitions of X═S and R²═H and/or N-alkylphosphoric acid triamides with the definitions of X═O and R²═H.

21. The emulsion of claim 19, wherein phase A comprises at least one compound containing an amino group or a substituted amino group and having a boiling point of more than 100° C., as component A3.

22. The emulsion of claim 19, wherein phase A further comprises a polymer in dissolved or dispersed form as component C.

23. The emulsion of claim 19, wherein components A1 and B1 are present in a weight ratio in the range from 1:1 to 1:6.

24. The emulsion of claim 19, wherein component A1 used is N-(n-butyl)thiophosphoric acid triamide or a mixture of N-(n-butyl)thiophosphoric acid triamide and N-(n-propyl)thiophosphoric acid triamide.

25. The emulsion of claim 19, wherein component A2 is selected from water-immiscible alcohols, ethers, esters, hydrocarbons, polyalkylene polyols and ethers thereof, liquid amides, or mixtures thereof.

26. The emulsion of claim 19, wherein phase B has a pH in the range from 6 to 9.

27. The emulsion of claim 19, wherein phase A comprises 15% to 35% by weight of component A1, based on the total weight of phase A.

28. The emulsion of claim 19, wherein phase B comprises 20% to 60% by weight of component B1, based on the total weight of phase B.

29. The method of using an emulsion of claim 19 as an additive or a coating composition for urea-containing nitrogen fertilizers.

30. The method of claim 29, wherein the emulsion is deployed on soil or plant substrate separately or simultaneously with the fertilizer or is introduced into the fertilizer or applied to the fertilizer.

31. A process for producing treated urea-containing fertilizers, comprising the steps of
a) separately producing phases A and B as defined in claim 19,
b) mixing phases A and B from step a) for production of an emulsion of phases A and B, and
c) applying the emulsion from step b) to a particulate urea-containing fertilizer or introducing the emulsion from step b) into a particulate urea-containing fertilizer.

32. The process of claim 31, wherein there is a period of not more than 60 seconds between step c) and step b).

33. The process of claim 31, wherein the emulsion is applied to the urea-containing fertilizer in step c) by spray and/or drum application.

34. The process of claim 31, wherein the emulsion is applied to the urea-containing fertilizer or introduced into the urea-containing fertilizer in step c) in such an amount that the total content of components A and B, based on the urea present in the fertilizer, is 0.02% to 0.38% by weight.

35. The process of claim 31, wherein the emulsion is applied to the surface of the particulate urea-containing fertilizer in step c).

36. A urea-containing fertilizer obtainable by the process of claim 31.

37. The emulsion of claim 19, wherein the 2-(N-3,4-dimethylpyrazole)succinic acid is in the form of a dialkali metal salt, alkaline earth metal salt, diammonium salt or mixture thereof.

38. The emulsion of claim 21, wherein the at least one compound containing an amino group or a substituted amino group and having a boiling point of more than 100° C. is an amine.

39. The emulsion of claim 38, wherein the amine is selected from methyldiethanolamine, tetrahydroxypropylethylenediamine, trimethylaminoethylethanolamine, N,N,N′,N′-tetramethylhexane-1,6-diamine, N,N′,N″-tris(dimethylaminopropyl)hexahydrotriazine, 2,2′-dimorpholinyldiethyl ether, N,N,N′,N′,N″,N″-hexamethyl-1,3,5-triazine-1,3,5(2H,4H,6H)-tripropanamine, N,N,N′,N′-tetrakis(2-hydroxypropyl)ethylenediamine, or mixtures thereof.

40. The emulsion of claim 21, wherein component A3 is in at least 0.2 times the molar amount of component A1.

41. The emulsion of claim 23, wherein components A1 and B1 are present in a weight ratio in the range from 1:1.5 to 1:5.

42. The emulsion of claim 41, wherein components A1 and B1 are present in a weight ratio in the range from 1:2 to 1:4.5

43. The emulsion of claim 25, wherein component A2 is selected from 2-propyl-1-heptanol, dimethyl phthalate, benzyl alcohol, or mixtures thereof.

44. The emulsion of claim 26, wherein phase B has a pH in the range from 7 to 8.

45. The emulsion of claim 27, wherein phase A comprises 20% to 30% by weight of component A1, based on the total weight of phase A.

46. The emulsion of claim 45, wherein phase A comprises 22% to 26.5% by weight of component A1, based on the total weight of phase A.

47. The emulsion of claim 28, wherein phase B comprises 25% to 50% by weight of component B1, based on the total weight of phase B.

48. The emulsion of claim 28, wherein phase B comprises 30% to 40% by weight of component B1, based on the total weight of phase B.

49. The process of claim 32, wherein there is a period of not more than 30 seconds between step c) and step b).

50. The process of claim 34, wherein the emulsion is applied to the urea-containing fertilizer or introduced into the urea-containing fertilizer in step c) in such an amount that the total content of components A and B, based on the urea present in the fertilizer, is 0.04% to 0.27% by weight.
